(19) United States
(12) Patent Application Publication
(10) Pub. No.: US 2015/0315456 A1
(43) Pub. Date: Nov. 5, 2015

(54) METHODS FOR TREATING A SUBTERRANEAN WELL

(71) Applicant: SCHLUMBERGER TECHNOLOGY CORPORATION, Sugar Land, TX (US)

(72) Inventors: Arthur Milne, Quito (EC); Emilio Jose Miquilena, Campech (MX); Syed A. Ali, Sugar Land, TX (US)

(21) Appl. No.: 14/649,220

(22) PCT Filed: Nov. 21, 2013
(86) PCT No.: PCT/US2013/071125

§ 371 Date: Jun. 3, 2015

Related U.S. Application Data
(60) Provisional application No. 61/732,757, filed on Dec. 3, 2012.

(51) Int. Cl. C09K 8/588; E21B 43/16

(52) U.S. Cl. CPC C09K 8/588; E21B 43/16

(57) ABSTRACT

Fluid compositions comprising water, an acid or an acid source, a chelating agent and a relative permeability modifier have utility in the context of matrix acidizing of oil bearing sandstone formations. Acidizing treatments with these compositions may improve the formation permeability to oil with respect to the permeability to water. The relative permeability modifier is a cationic polyacrylamide.

### BACKGROUND

The statements in this section merely provide background information related to the present disclosure and may not constitute prior art.

The present disclosure broadly relates to compositions and methods for treating one or more formations in a subterranean well such that the formations have a reduced permeability to water.

Formations containing oil or gas in many cases also have water present. These formations will produce water along with the hydrocarbons; however, due to the heterogeneity of many formations, water will flow preferentially from certain intervals. When low viscosity treating fluids are injected into the matrix of the formation, below the fracturing pressure, such as in matrix acidizing to try to increase the production of fluids from the reservoir, there is a tendency for the treating fluid to enter preferentially into the intervals with the highest water saturation, due to the lower viscosity and higher mobility of water compared to oil in most reservoirs. The increase in water production after these treatments is usually greater than any associated increase in oil or gas.

A relative permeability modifier (RPM) is generally a compound, usually a polymer, which when injected into a formation will adsorb onto the surface of the rock matrix and significantly reduce the relative permeability of the formation to water. Following an RPM treatment, the formation should produce oil and/or gas at about the same or at an increased rate as prior to the treatment, but with less water due to the reduced effective permeability of the formation to water. Reducing the relative permeability to water in intervals which have high water saturation should, in theory, decrease water production from these intervals after the treatment.

One approach is to inject the reactive fluids into the formation and then in a separate treatment inject a Relative Permeability Modifier (RPM) to decrease the relative permeability to water of the water saturated intervals previously stimulated. The results of these treatments indicate that the RPM does not necessary flow into the same intervals that were stimulated by the reactive fluids. One reason for this may be the difference in viscosity between the reactive treating fluids and the RPM.

A more reliable approach may be to include the RPM in the reactive treating fluid ensuring that the stimulated intervals are the same intervals in which the relative permeability to water is decreased.

### SUMMARY

The present disclosure reveals compositions and methods by which the water permeability of subterranean formations may be decreased.

In an aspect, embodiments relate to compositions that comprise water, an acid or an acid source, a chelating agent and a relative permeability modifier. The relative permeability modifier comprises at least one cationic polyacrylamide.

In a further aspect, embodiments relate to methods for treating a subterranean formation penetrated by a wellbore. A composition is prepared that comprises water, an acid or an acid source, a chelating agent and a relative permeability modifier. The relative permeability modifier comprises at least one cationic polyacrylamide. The composition is then introduced into the subterranean formation.

In yet a further aspect, embodiments relate to methods for reducing the water permeability of a subterranean formation penetrated by a wellbore. A first composition is prepared that comprises water, an acid or an acid source, and a chelating agent. The first composition is placed into the formation at a pressure that does not fracture the formation. A second composition is prepared that comprises water, an acid or an acid source, a chelating agent and a relative permeability modifier. The relative permeability modifier comprises at least one cationic polyacrylamide. The second composition is then placed into the formation at a pressure that does not fracture the formation. A third composition is prepared that comprises water and at least one cationic polyacrylamide. The third composition is then placed into the formation at a pressure that does not fracture the formation. The first, second and third compositions are allowed to remain in the formation for a period of time, and are then allowed to flow out of the wellbore.

### BRIEF DESCRIPTION OF THE DRAWINGS

FIG. 1 shows the results of a core-flow tests during which a sandstone core was treated with a chelant-based acidizing fluid containing a cationic polyacrylamide relative permeability modifier. The fluid contained ammonium bifluoride as an acid source. The chelant was diammonium ethylenediaminetetraacetic acid.

FIG. 2 shows the results of a core-flow test during which a sandstone core was treated with a chelant-based acidizing fluid that did not contain a cationic polyacrylamide relative permeability modifier. The fluid contained ammonium bifluoride as an acid source. The chelant was diammonium ethylenediaminetetraacetic acid.

FIG. 3 shows the results of a core-flow tests during which a sandstone core was treated with a chelant-based acidizing fluid containing a cationic polyacrylamide relative permeability modifier. The fluid contained ammonium bifluoride as an acid source as well as boric acid. The chelant was diammonium ethylenediaminetetraacetic acid.

FIG. 4 shows shows the results of a core-flow test during which a sandstone core was treated with a chelant-based acidizing fluid that did not contain a cationic polyacrylamide relative permeability modifier. The fluid contained ammonium bifluoride as an acid source as well as boric acid. The chelant was diammonium ethylenediaminetetraacetic acid.

FIG. 5 shows the results of a core-flow tests during which a sandstone core was treated with a chelant-based acidizing fluid containing a cationic polyacrylamide relative permeability modifier. The fluid contained hydrochloric acid. The chelant was trisodium hydroxyethylethylenediamine-triacetate.

### DETAILED DESCRIPTION

At the outset, it should be noted that in the development of any such actual embodiment, numerous implementationspecific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

In mature fields it is common practice to perform matrix acidizing treatments on formations that are producing fluids with a high water/oil ratio. In these cases it is very common that the amount of water produced after the treatment increases substantially, with only a small or no increase in crude production. The water production increase is often attributed to the higher effective water permeability of the intervals in the formation with the highest water saturation compared with those intervals saturated with crude, as well as the viscosity difference between the crude and water and the relative permeability to oil and water. Thus, the treatment effectively stimulates the intervals with higher water saturation.

One approach for remedying this problem is to inject the reactive fluids into the formation and then, in a separate treatment, inject a Relative Permeability Modifier (RPM) to decrease the relative permeability to water of the water saturated intervals previously stimulated. However, the results of these treatments indicate that the RPM does not necessary flow into the same intervals that were stimulated by the reactive fluids. One reason for this may be the viscosity difference between the reactive treating fluids and the RPM.

A more reliable approach may be to include the RPM in the reactive treating fluid, thus ensuring that the RPM flows into the stimulated intervals. The Applicants have determined that cationic polyacrylamide-based RPMs may be incorporated into chelant-based acidizing fluids that may also contain organic or inorganic acids or acid sources. The present disclosure is aimed at the stimulation of sandstone formations.

The chelant based acidizing fluids of the present disclosure are the same as those described in the following patents: U.S. Pat. No. 6,436,889; U.S. Pat. No. 7,192,908 and U.S. Pat. No. 7,589,050, the entire contents of which are incorporated by reference. One example of a suitable cationic polyacrylamide-based RPM is ZETAG™ 7565, manufactured by BASF, and described as ethanaminium, N,N,N-trimethyl-2-[(1-oxo-2-propenyl)oxy]-, chloride, polymer with 2-propenamide.

In an aspect, embodiments relate to compositions that comprise water, an acid or an acid source, a chelating agent and a relative permeability modifier. The relative permeability modifier comprises at least one cationic polyacrylamide.

In a further aspect, embodiments relate to methods for treating a subterranean formaton penetrated by a wellbore. A composition is prepared that comprises water, an acid or an acid source, a chelating agent and a relative permeability modifier. The relative permeability modifier comprises at least one cationic polyacrylamide. The composition is then introduced into the subterranean formation.

In yet a further aspect, embodiments relate to methods for reducing the water permeability of a subterranean formation penetrated by a wellbore. A first composition is prepared that comprises water, an acid or an acid source, and a chelating agent. The first composition is placed into the formation at a pressure that does not fracture the formation. A second composition is prepared that comprises water, an acid or an acid source, a chelating agent and a relative permeability modifier. The relative permeability modifier comprises at least one cationic polyacrylamide. The second composition is then placed into the formation at a pressure that does not fracture the formation. A third composition is prepared that comprises water and at least one cationic polyacrylamide. The third composition is then placed into the formation at a pressure that does not fracture the formation. The first, second and third compositions are allowed to remain in the formation for a period of time, and are then allowed to flow out of the wellbore. The period of time, or “shut-in” time, may be between 6 and 24 hours.

For all aspects, the acid source may comprise ammonium bifluoride, present at a concentration between 0.5 wt % and 6.0 wt %, between 2 wt % and 4 wt %, or between 2.5 wt % and 3.5 wt %. The composition may further comprise boric acid at concentrations between 0.5 wt % and 6.0 wt %, or between 0.5 wt % and 3.0 wt %, or between 1.0 wt % and 2 wt %. The ammonium bifluoride and boric acid react in situ to form fluoboric acid. Alternatively, hydrochloric acid may be present at a concentration such that the pH of the composition is between 2.0 and 4.5, or between 2.6 and 4.5, or between 3.5 and 4.0.

For all aspects, the chelating agent may comprise maleic acid, tartaric acid, citric acid, nitrilotriacetic acid, hydroxethyliminodiacetic acid, hydroxyethylethylenediaminetetraacetic acid, ethylenediaminetetraacetic acid (EDTA), cyclohexylenediaminetetraacetic acid, diethylenetriaminepentaacetic acid, ammonium salts thereof, lithium salts thereof, sodium salts thereof, and mixtures thereof. The chelating agent may comprise diammonium ethylenediaminetetraacetic acid, present at a concentration between about 17 wt % and about 30 wt %, or between 20 wt % and 25 wt %. The chelating agent may comprise hydroxyethylethylenediaminetetraacetic acid, present at a concentration between 20 wt % and 45wt %, or between 20 wt % and 25 wt %.

For all aspects, the polyacrylamide may be ethanaminium, N,N,N-trimethyl-2-[(1-oxo-2-propenyl)oxy]-, chloride, polymer with 2-propenamide, present at a concentration between 0.6 kg/m³ and 6.0 kg/m³, or between 1.5 kg/m³ and 3.5 kg/m³, or between 2.0 kg/m³ and 2.5 kg/m³.

The following examples serve to further illustrate the disclosure.

### EXAMPLES

Core-flow tests were performed according to assess the effects of chelant-based fluid systems on the water and oil permeabilities of Berea sandstone cores. Relative permeabilities were calculated according to the well-known Johnson, Bossier and Naumann method, also referred to as the JBN method, described in the following publication. Johnson E F et al.: “Calculation of Relative Permeability from Displacement Experiments,” Petroleum Transactions of AIME, v. 216, pp. 370-372 (1959).

The core-flow test procedure for all of the following examples is given below.
1. Clean and dry the core, record dimensions and weigh.
2. Place the core in a saturator filled with synthetic brine (5 wt % NH₄Cl) and connect the saturator to a vacuum overnight, removing air from the core and saturatint the pore space entirely with the brine.
3. Calculate the pore volume of the core by taking into account the density of saturation fluid and weight gain of the core owing to fluid saturation.
4. Load the core into the core-flow apparatus and apply 6.9 MPa (1000 psi) pressure to simulate overburden.
5. Heat the cell to the operating temperature, maintaining 6.9 MPa overburden pressure as well as 3.5 MPa (500 psi) backpressure.
6. Measure the initial, stable oil permeability while pumping crude oil in the production direction at 2 mL/min.
7. Measure the initial, stable oil permeability while pumping crude oil in the injection direction at 2 mL/min.
8. Measure the final oil permeability while pumping crude oil in the production direction at 2 mL/min.
9. Inject up to 18 pore volumes of 5 wt % NH₄Cl brine into the core at 2 mL/min in the production direction.
10. Measure the final, stable water permeability while pumping 5% NH₄Cl in the production direction at 2 mL/min.
11. Inject up to 15 pore volumes of the chelant-based treatment fluid in the injection direction at 2 mL/min.
12. Shut in for 14 hours, maintaining the confining pressures and temperature.
13. Inject crude oil in the production direction at 2 mL/min in production direction and measure the stable permeability
14. Inject up to 18 pore volumes of 5% NH₄Cl in the production direction at 2 mL/min.
15. Inject crude oil in the production direction at 2 mL/min and measure final stable permeability.
   The crude oil used in all of the examples had an API gravity of 40° .

### Example 1

The chelant-based treatment fluid composition is given in Table 1.

TABLE 1
Treatment fluid composition.

| Additive | Concentration | |
|---|---|---|
| diammonium | 50 | wt % |
| EDTA | | |
| ammonium | 10.8 | g/L |
| bifluoride | | |
| methanol-based | 0.1 | vol % |
| demulsifying | | |
| agent | | |
| ZETAG ™ 7565 | 2.4 | g/L |
| water | 49.5 | vol % |

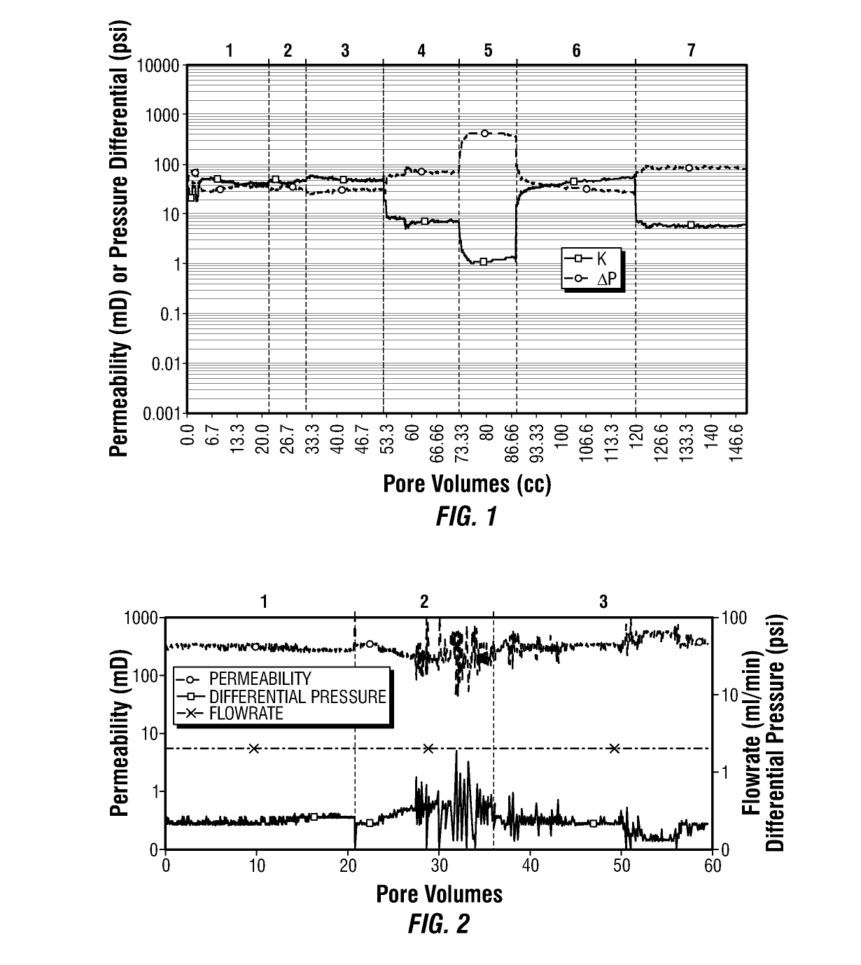

The treatment temperature was 100° C. The permeabilities and pressure differentials recorded during the test are plotted in FIG. 1. The data are divided into seven columns, described below.
1. Crude oil flowing in production direction.
2. Crude oil flowing in injection direction.
3. Crude oil flowing in production direction. Measurement of initial oil permeability.
4. Brine flowing in production direction. Measurement of initial water permeability.
5. Chelant-based treatment fluid. 14-hr shut-in.
6. Crude oil flowing in production direction. Measurement of final oil permeability.
7. Brine flowing in production direction. Measurement of final water permeability.

The initial and final oil permeabilities were 47.6 mD and 53.3 mD, respectively. The initial and final water permeabilities were 7.2 mD and 5.9 mD, respectively. Thus, the oil permeability increased by 12% and the water permeability fell 18%.

### Example 2

The chelant-based treatment fluid composition is given in Table 2. The composition is the same as that of Example 1, except that the RPM (ZETAG™ 7565) was not present.

TABLE 2
Treatment fluid composition.

| Additive | Concentration | |
|---|---|---|
| diammonium EDTA | 50 | vol % |
| ammonium bifluoride | 10.8 | g/L |
| methanol-based | 0.1 | vol % |
| demulsifying agent | | |
| water | 49.5 | vol % |

The treatment temperature was 100° C. The permeabilties and pressure differentials recorded during the test are plotted in FIG. 2. The data are divided into three columns, described below.
1. Brine flowing in injection direction.
2. Chelant-based treatment fluid. 14-hours shut-in.
3. Brine flowing in production direction.

The initial and final brine permeabilities were 279.1 mD and 345.5 mD, respectively. Thus, the water permeability increased 23%.

### Example 3

The chelant-based treatment fluid is given in Table 3.

TABLE 3
Treatment fluid composition.

| Additive | Concentration | |
|---|---|---|
| diammonium EDTA | 50 | vol % |
| ammonium bifluoride | 21.6 | g/L |
| boric acid | 10.8 | g/L |
| ZETAG ™ 7565 | 2.4 | g/L |
| methanol-based | 0.2 | vol % |
| demulsifying agent | | |
| water | 47.9 | vol % |

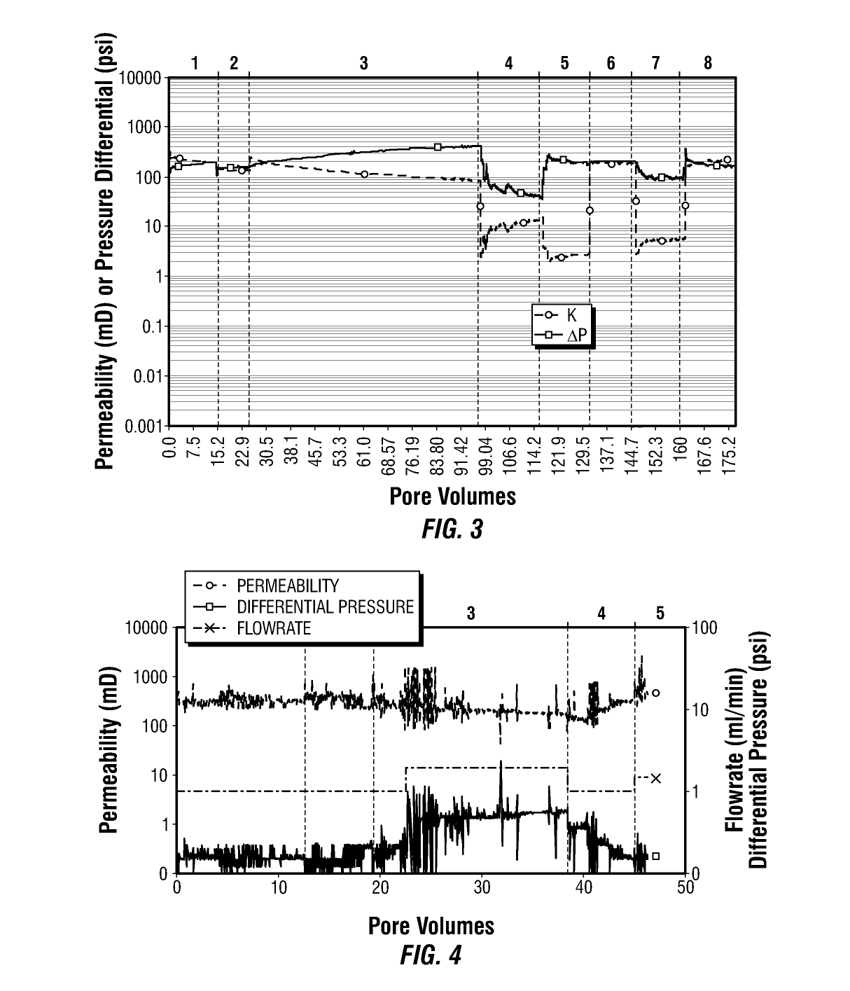

The treatment temperature was 100° C. The permeabilities and pressure differentials recorded during the test are plotted in FIG. 3. The data are divided into eight columns, described below.
1. Crude oil flowing in production direction.
2. Crude oil flowing in injection direction.
3. Crude oil flowing in production direction. Measurement of initial oil permeability.
4. Brine flowing in production direction. Measurement of initial water permeability.
5. Chelant-based treatment fluid. 14-hr shut-in.
6. Crude oil flowing in production direction. Measurement of final oil permeability.
7. Brine flowing in production direction. Measurement of final water permeability.
8. Crude oil flowing in production direction.

The initial and final oil permeabilities were 85.8 mD and 183.0 mD, respectively. The initial and final water permeabilities were 12.8 mD and 5.3 mD, respectively. Thus, the oil permeability increased by 113% and the water permeability fell 58.6%.

### Example 4

The chelant-based treatment fluid is given in Table 4. The composition is the same as that of Example 3, except that the RPM (ZETAG™ 7565) was not present.

TABLE 4
Treatment fluid composition.

| Additive | Concentration | |
|---|---|---|
| diammonium EDTA | 50 | vol % |
| ammonium bifluoride | 21.6 | g/L |
| boric acid | 10.8 | g/L |
| methanol-based | 0.2 | vol % |
| demulsifying agent | | |
| water | 47.9 | vol % |

The treatment temperature was 100° C. The permeabilties and pressure differentials recorded during the test are plotted in FIG. 2. The data are divided into five columns, described below.
1. Brine flowing in production direction. Water permeability measurement: 327.5 mD.
2. Brine flowing in injection direction. Water permeability measurement: 223.3 mD.
3. Chelant-based treatment fluid. 14-hr shut-in.
4. Brine flowing in injection direction. Water permeability measurement: 327.5 mD. Either initial or final measurement is incorrect.
5. Brine flowing in production direction. Water permeability measurement: 491.3 mD.

The water permeability increased 147% in the injection direction and 150% in the production direction.

### Example 5

The chelant-based treatment fluid is given in Table 5. Unlike the previous examples, the chelant in this case was trisodium hydroxyethylethylenediamine-triacetate. Hydrochloric acid was added to adjust the fluid pH to 4.0.

TABLE 5
Treatment fluid composition.

| Additive | Concentration | |
|---|---|---|
| trisodium | 45 | vol % |
| hydroxyethylethylenediamine- | | |
| triacetate | | |
| 36% HCl | 13.5 | vol % |
| ZETAG ™ 7565 | 2.4 | g/L |
| methanol-based demulsifying | 0.2 | vol % |
| agent | | |
| water | 41.3 | vol % |

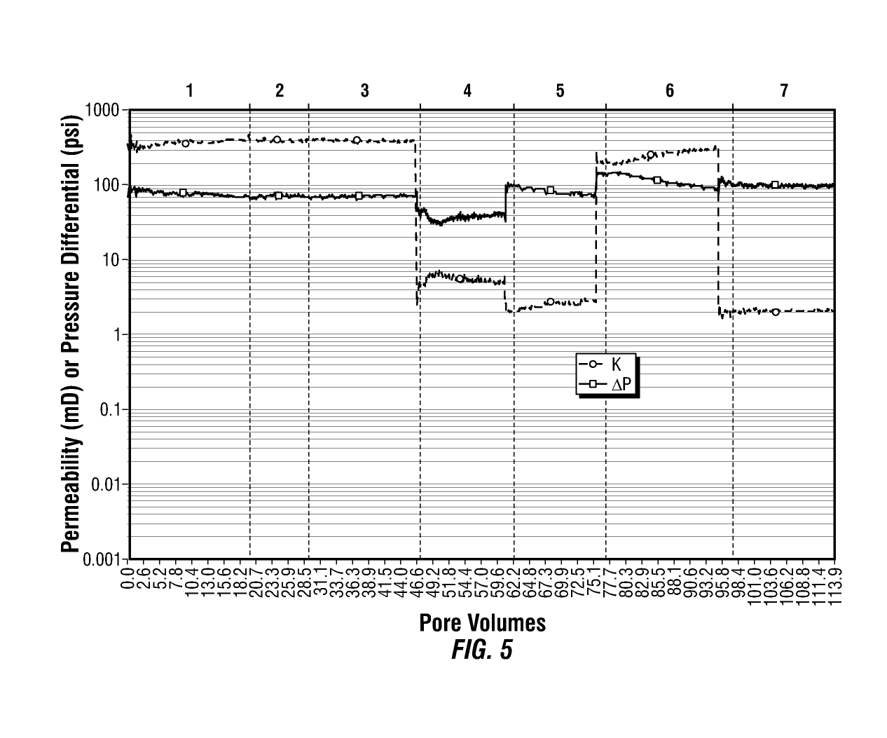

The treatment temperature was 100° C. The permeabilties and pressure differentials recorded during the test are plotted in FIG. 5. The data are divided into seven columns, described below.
1. Crude oil flowing in production direction.
2. Crude oil flowing in injection direction.
3. Crude oil flowing in production direction. Measurement of initial oil permeability.
4. Brine flowing in production direction. Measurement of initial water permeability.
5. Chelant-based treatment fluid. 14-hr shut-in.
6. Crude oil flowing in production direction. Measurement of final oil permeability.
7. Brine flowing in production direction. Measurement of final water permeability.

The initial and final oil permeabilities were 388 mD and 301 mD, respectively. The initial and final water permeabilities were 5.2 mD and 2.1 mD, respectively. Thus, the oil permeability fell by 22.4% and the water permeability fell 59.6%. Although the core permeability to both fluids decreased, the permeability to water fell to greater extent than that to oil.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A composition, comprising water, an acid or an acid source, a chelating agent and a relative permeability modifier, wherein the relative permeability modifier comprises at least one cationic polyacrylamide.

2. The composition of claim 1, wherein the acid source comprises ammonium bifluoride, present at a concentration between 0.5 wt % and 6.0 wt %.

3. The composition of claim 1, further comprising boric acid at a concentration between 0.5 wt % and 6.0 wt %.

4. The composition of claim 1, wherein the acid comprises hydrochloric acid, present at a concentration such that the composition has a pH between 2.0 and 4.5.

5. The composition of claim 1, wherein the chelating agent comprises maleic acid, tartaric acid, citric acid, nitrilotriacetic acid, hydroxethyliminodiacetic acid, hydroxyethylethylenediaminetetraacetic acid, ethylenediaminetetraacetic acid, cyclohexylenediaminetetraacetic acid, diethylenetriaminepentaacetic acid, or ammonium salts thereof, or lithium salts thereof, or sodium salts thereof, or mixtures thereof.

6. The composition of claim 1, wherein the chelating agent comprises diammonium ethylenediaminetetraacetic acid, present at a concentration between about 17 wt % and about 30 wt %.

7. The composition of claim 1, wherein the polyacrylamide is ethanaminium, N,N,N-trimethyl-2-[(1-oxo-2-propenyl)oxy]-, chloride, polymer with 2-propenamide, present at a concentration between 0.6 kg/m³ and 6.0 kg/m³.

8. A method for treating a subterranean formation penetrated by a wellbore, comprising:
(i) preparing a composition comprising water, an acid or an acid source, a chelating agent and a relative permeability modifier, wherein the relative permeability modifier comprises at least one cationic polyacrylamide; and
(ii) introducing the composition into the subterranean formation.

9. The method of claim 8, wherein the acid source comprises ammonium bifluoride, present at a concentration between 0.5 wt % and 6.0 wt %.

10. The method of claim 8, wherein the composition further comprises boric acid at a concentration between 0.5 wt % and 6.0 wt %.

11. The method of claim 8, wherein the chelating agent comprises maleic acid, tartaric acid, citric acid, nitrilotriacetic acid, hydroxethyliminodiacetic acid, hydroxyethylethylenediaminetetraacetic acid, ethylenediaminetetraacetic acid, cyclohexylenediaminetetraacetic acid, diethylenetriaminepentaacetic acid, or ammonium salts thereof, or lithium salts thereof, or sodium salts thereof, or mixtures thereof.

12. The method of claim 8, wherein the chelating agent comprises diammonium ethylenediaminetetraacetic acid, present at a concentration between about 17 wt % and 30 wt %.

13. The method of claim 8, wherein the polyacrylamide is ethanaminium, N,N,N-trimethyl-2-[(1-oxo-2-propenyl)oxy]-, chloride, polymer with 2-propenamide, present at a concentration between 0.6 kg/m³ and 6.0 kg/m³.

14. A method for reducing the water permeability of a subterreanean formation penetrated by a wellbore, comprising:
(i) preparing a first composition comprising water, an acid or an acid source and a chelating agent;
(ii) placing the first composition into the formation at a pressure that does not fracture the formation;
(iii) preparing a second composition comprising water, an acid or an acid source, a chelating agent and a relative permeability modifier, wherein the relative permeability modifier comprises at least one cationic polyacrylamide;
(iv) placing the second composition into the formation at a pressure that does not fracture the formation;
(v) preparing a third composition comprising water and at least one cationic polyacrylamide;
(vi) placing the third composition into the formation at a pressure that does not fracture the formation;
(vii) allowing the first, second and third compositions to remain in the formation for a period of time; and
(viii) allowing the first, second and third compositions to flow out of the wellbore.

15. The method of claim 14, wherein the period of time during which the first, second and third compositions remain in the formation is between 6 and 24 hours.

16. The method of claim 14, wherein the acid source comprises ammonium bifluoride, present at a concentration between 0.5 wt % and 6.0 wt %.

17. The method of claim 14, wherein the composition further comprises boric acid at a concentration between 0.5 wt % and 6.0 wt %.

18. The method of claim 14, wherein the chelating agent comprises maleic acid, tartaric acid, citric acid, nitrilotriacetic acid, hydroxethyliminodiacetic acid, hydroxyethylethylenediaminetetraacetic acid, ethylenediaminetetraacetic acid, cyclohexylenediaminetetraacetic acid, diethylenetriaminepentaacetic acid, or ammonium salts thereof, or lithium salts thereof, or sodium salts thereof, or mixtures thereof.

19. The method of claim 14, wherein the chelating agent comprises diammonium ethylenediaminetetraacetic acid, present at a concentration between about 17 wt % and about 30 wt %.

20. The method of claim 14, wherein the polyacrylamide is ethanaminium, N,N,N-trimethyl-2-[(1-oxo-2-propenyl)oxy]-, chloride, polymer with 2-propenamide, present at a concentration between 0.6 kg/m³ and 6.0 kg/m³.
